(19) United States
(12) Patent Application Publication
(10) Pub. No.: US 2009/0228929 A1
(43) Pub. Date: Sep. 10, 2009

(54) MEDIA RECORDING SELECTION SYSTEM

(75) Inventor: Richard Thomas Cass, Middlesex (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: British Sky Broadcasting Limited, Isleworth, Middlesex (GB)

(21) Appl. No.: 12/158,951

(22) PCT Filed: Dec. 22, 2006
(86) PCT No.: PCT/GB06/04918

§ 371 Date: Nov. 21, 2008

(30) Foreign Application Priority Data
Dec. 22, 2005 (GB) 0526218.3

(51) Int. Cl. G06F 13/10; H04W 4/00

(52) U.S. Cl. 725/58; 455/466; 386/83

(57) ABSTRACT

In a remote booking system allowing a user to select programmes to be recorded on a personal video recorder (PVR) (1) by sending messages from a mobile device (3), the system receives a “natural language” message identifying a programme by information generally available to the user, and attempts to match the received message to programmes in a programme schedule. If there is only one matching programme, the system instructs the user's PVR (1) to record that programme, and may optionally send a message to the mobile device (3) confirming the programme to be recorded. If there are a plurality of matching programmes, the system may send a message to the mobile device (3) listing the matching programmes. The user replies to the message by identifying one of the matching programmes, and the system then instructs the user's PVR (1) to record that programme.

### FIELD OF THE INVENTION

This invention relates to a media recording system, particularly but not exclusively to a remote booking system that allows remote selection of programmes to be recorded by a personal video recorder (PVR).

### BACKGROUND OF THE INVENTION

In conventional PVR systems, such as the Sky⁺ (RTM) system, a broadcast receiver or set-top box (STB) stores a schedule of programmes to be broadcast on different channels and at different times, and presents this schedule to the user in an interactive electronic programme guide (IEPG). The user selects desired programmes or series of programmes by means of a local remote control, which are then recorded on a local recording medium, such as a hard disc, as they are broadcast. The recorded programmes may then be viewed at a time convenient to the user, and may be stored for repeated viewing or erased automatically after they are viewed. The programmes are broadcast and stored in encrypted form, the decryption process being managed via a smart card. Some programmes may be provided on a ‘pay-per-view’ basis, so that they may only be viewed if an additional payment has been made and a specific authorisation sent to the STB. A PVR system allows the user to build a collection of desired programmes, by referring to the IEPG and selecting the programmes individually or as a series from the schedule. In such conventional systems, the user must be in the vicinity of the PVR so as to view the IEPG and select the desired programmes with the remote control. It would be desirable to allow the user to select desired programmes for recording by the PVR, remotely from the PVR.

The NDS World Vision electronic newsletter, issue 21, ‘SMS meets Pay-per-View—Ask Your Phone What to Watch’, J Deutsch, February 2004, available on 25^{th} November 2005 at:
http://www.nds.com/worldvision/twenty_one/article4.html
   describes a ‘remote booking’ system in which a user receives programme information via a short messaging service (SMS) to their mobile device, containing a list of programmes each identified by a unique number. The user sends an SMS message identifying a programme by its unique number (e.g. ‘book program no. 1234), and the system sends a message to the user's PVR to record the corresponding programme. However, this system requires the system to identify programmes to the user by a unique number before the user can send a remote booking message.

### STATEMENT OF THE INVENTION

In one aspect of the invention, a media recording selection system includes an application that receives a message from a user, via a messaging service, identifying a programme to be recorded by information that is at least one of:
i) information not previously communicated to the user via the messaging service;
ii) information identified by a non-unique identifier;
iii) information that does not rely on a correspondence between an identifying code stored by the system and the identity of the programme; and
iv) at least one of programme title, broadcast date, broadcast time and broadcast channel.

In one embodiment, the system receives a ‘natural language’ message identifying a programme by information generally available to the user and attempts to match the received message to stored program information identifying programmes in a programme schedule. If there is only one matching programme, the system instructs the user's PVR to record that programme, and may optionally send a message to the user confirming the programme to be recorded. If there are a plurality of matching programmes, the system may send a message to the user listing the matching programmes. The user replies to the message by identifying one of the matching programmes, and the system then instructs the user's PVR to record that programme.

### BRIEF DESCRIPTION OF THE DRAWINGS

Specific embodiments of the present invention will now be described with reference to the accompanying drawings listed below.

FIG. 1 is a diagram of the architecture of an SMS-based remote booking system in an embodiment of the invention.

FIG. 2 is a flowchart of the function of a remote booking application in the system.

### DETAILED DESCRIPTION OF EMBODIMENTS OF THE INVENTION

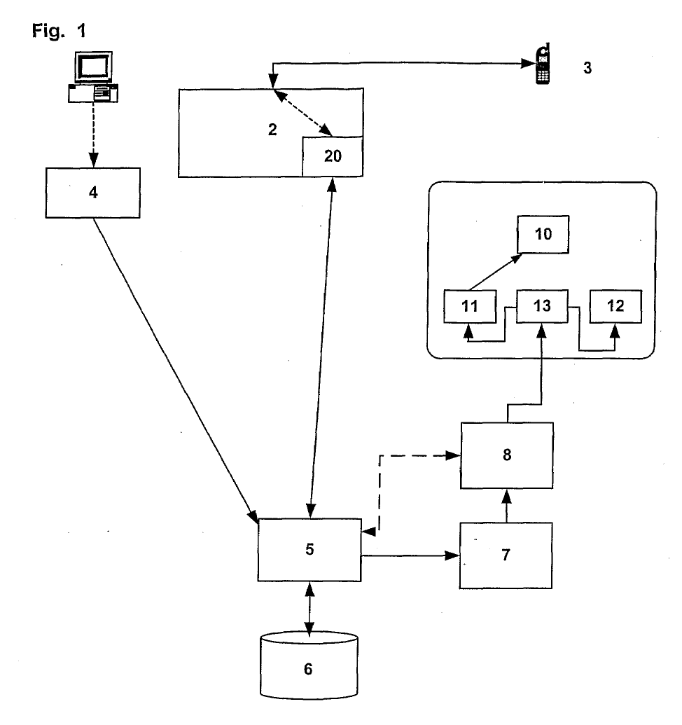

FIG. 1 is a diagram of the architecture of an SMS-based remote booking system in an embodiment of the invention. A PVR 1 is arranged to receive broadcast programmes having media content, such as audio and/or video content. The programmes may be broadcast over a satellite link and/or a cable network. The programmes are broadcast according to a predetermined schedule, in which a specific programme is broadcast at a predetermined time and date on a predetermined channel. One example of the PVR 1 is the Sky⁺ (RTM) PVR, available in the UK and Ireland under licence from the applicant, and modified as described below. Only one PVR 1 is shown in FIG. 1, but in practice there will be multiple such PVRs 1 belonging to different users. The user is associated with a specific PVR by subscription information stored by the broadcast service provider.

The PVR 1 stores and executes application software, including one or more interactive remote booking applications (iRBA) 10, which may be downloaded onto the PVR 1 from a broadcast channel or over a network. The PVR 1 also stores programme schedule information comprising an electronic programme guide (EPG) 11 and a personal schedule catalogue (PSC) 12, controlled by a broadcast notification (BN) engine 13. The BN engine 13 receives BN messages, from a broadcast channel or over a network, including remote booking messages indicating one or more programmes selected remotely for recording. In response to such remote booking messages, the selected programmes are added to the PSC 12, which controls the recording of the selected programmes by the PVR 1 at the corresponding times and on the corresponding channels identified by the EPG 11.

A mobile messaging system includes an SMS service centre 2 and a plurality of mobile messaging devices 3, which preferably implement a GSM (Groupe Speciale Mobile) SMS system. Such mobile messaging systems are well known and their complete architecture need not be described further. The advantageous features of such a system include the ability wirelessly to send short alphanumeric messages to and from mobile devices, and preferably to allow roaming of such messaging devices 3 between different radio cells.

A user of the PVR 1 pre-registers for the remote booking service, by identifying the mobile messaging device 3 belonging to the user. The identification may be the calling number of the mobile messaging device 3, that is passed automatically by the SMS service centre 2 to external systems together with a message received from the mobile messaging device 3. The user also identifies the user's PVR 1, for example to providing a username and password corresponding to the user's subscription to a broadcast service available to the PVR 1. Hence, the pre-registration sets up an association between the mobile messaging device 3 and the PVR 1. The pre-registration may be performed through the iRBA 10, or through a web server 4. The user can then send remote booking messages which are identified by the system and used to send booking instructions to the corresponding user's PVR 1.

For example, the user may be away from home, discussing a programme series with friends, and may want to record the next episode of that series. The user may have only partial information about the programme, such as ‘the next episode of Lost is on e4 tonight’. The user composes an SMS message ‘lost, e4, tonight’ and sends it to a predetermined number corresponding to the remote booking service.

The message is received at the SMS centre 2 and is processed by a remote booking SMS application 20, which forwards the message to a remote booking application (RBA) 5, preferably remote from the SMS centre 2. The RBA 5 accesses a remote booking database 6 containing a programme schedule of programmes available for reception and recording by the PVR 1. The programme schedule identifies the title of each programme, together with its broadcast channel, date and time. Optionally, further information may be provided about at least some of the programmes, such as the names of actors appearing in the programme.

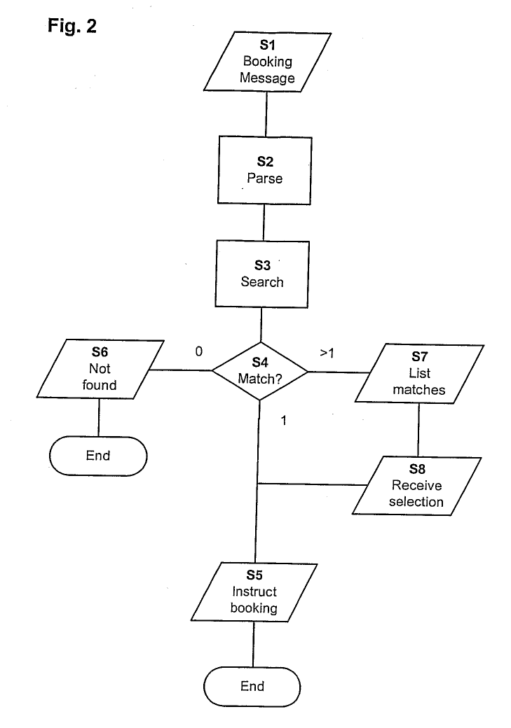

The operation of the RBA 5 is illustrated by the flowchart in FIG. 2. The RBA 5 receives (S1) the message, and parses (S2) the received message to identify different fields within the message. In the given example, fields are separated by a punctuation mark, such as a comma or full stop, and the RBA 5 parses the punctuation mark as a field delimiter. The RBA 5 may require the fields to be listed in a predetermined order. Next, the RBA 5 identifies the type of each field; this may be derived from the order of the fields, or by searching a list of possible values for each field. For example, the RBA 5 may identify ‘e4’ as a channel by searching a list of possible channels. The RBA 5 includes a natural language function that identifies ‘today’ or ‘tonight’ as a date equal to the current date, ‘tomorrow’ as the date following the current date, and the days of the week as the next date having that day of the week. The remaining field ‘lost’ is identified as being neither a date or time nor a channel, and is identified as part of a title or optionally the further information. If the RBA 5 is unable to parse the message, or to identify any of the field types in the message, it sends a reply message indicating that the remote booking request was not understood.

The RBA 5 then performs a search (S3) in the database 6 using the fields and field values identified in the message and determines (S4) whether any of the database entries match. In this case, the database 6 contains only one entry corresponding to programme scheduled to be broadcast on the current date, on channel e4, and containing the word ‘lost’ in the title (or optionally the further information). The RBA 5 therefore sends to the mobile device 3 a confirmation message confirming that the desired programme has been identified, and sends a remote booking instruction (S5) to a broadcast notification server (BNS) 7, identifying the selected programme and the user for whom the selected programme is to be recorded. The BNS 7 sends the remote booking instruction to an authorization control centre (ACC) 8, that verifies that the user is authorised to use the remote booking service, identifies the corresponding PVR 1, and manages the broadcast of remote booking instructions to the BN engine 13 of the PVR 1, such that the PVR 1 records the selected programme. Receipt of the remote booking instructions by the BN engine 13 is confirmed by the iRBA 10 sending a confirmation message to the RBA 5. The confirmation message sent to the mobile device 3 may incur an additional charge to the user of the mobile device, to provide revenue to the operator of the SMS system.

If, during the search of the database 6, the RBA 5 finds no matches, then it sends a message to the mobile device 3 indicating that no matches were found (S6). However, if the RBA 5 finds multiple matches, it sends (S7) a list identifying the matched programmes to the mobile device 3. For example, the list may be a numbered list of the titles, date and time of broadcast, such as:
1. Lost, e4, 23:00, 21/12
2. Lost in Translation, Sky Movies 2, 23:30, 21/12

The user may then reply by sending a message (SS) identifying the number of the required programme (in this case, ‘1’ or ‘2’). This message is identified by the RBA 5 as a reply to the previously sent message, identifying a single programme from the list previously sent to the mobile device 3. The RBA 5 then proceeds to instruct (S5) the booking in the same way as when the initial message identifies a unique programme.

Note that the listed numbers do not uniquely identify a programme from all possible programmes in the schedule, but uniquely identify a programme within the state-based communication between the mobile device 3 and the RBA 5.

Optionally, the user may reply with more than one entry from the numbered list (‘1 2’), which is interpreted by the RBA as a selection of the multiple corresponding entries in the list.

The search performed by the RBA 5 may be a search for exact matches only, or may be a ‘fuzzy’ search in which the similarity between the search criteria and the programme entries in the database 6 is recorded. If there is one entry with a similarity much greater than the other entries, this entry is selected as a unique match. If there are a plurality of entries with approximately equal similarity to the search criteria, those entries may be identified as the multiple matches to the search criteria. A limit may be imposed on the number of matches indicated to the user and/or on the total length of the message listing the multiple matches, corresponding to the length constraint of a single message in the SMS messaging system.

### ALTERNATIVE EMBODIMENTS

The embodiments are described above purely by way of example, and variations may occur to the skilled person on reading the description, which nevertheless fall within the scope of the invention as defined by the claims.

1. A method of controlling a broadcast recorder (1) with a mobile messaging device (3), comprising the steps of:
a. associating the broadcast recorder (1) with the mobile messaging device (3),
b. receiving a recording request (SI) from the mobile messaging device (3),
c. performing a search (S3) based on the recording request in a schedule of programmes to be broadcast, and if a programme is found (S4) corresponding to the recording request,
d. sending (S5) to the broadcast recorder (1) a recording instruction identifying the programme corresponding to the recording request;
wherein the recording request has one or more of the following characteristics:
i) the recording request comprises a plurality of discrete fields each for partially identifying a programme within the schedule of programmes;
ii) the recording request includes at least a part of one or more of the title, broadcast time, broadcast date and broadcast channel of a programme;
iii) the recording request includes a relative date identifier for identifying a date with reference to the current date;
iv) the recording request does not include information previously communicated to the mobile messaging device (3);
v) the recording request does not include a predetermined code uniquely identifying a programme within the schedule
vi) the recording request does not uniquely identify a programme within the schedule.

2. A method of controlling a broadcast recorder (1) with a mobile messaging device (3), comprising the steps of:
a. associating the broadcast recorder (1) with the mobile messaging device (3),
b. receiving a recording request (S1) from the mobile messaging device (3),
c. performing a search (S3) based on the recording request in a schedule of programmes to be broadcast, and if a programme is found (S4) corresponding to the recording request,
d. sending (S5) to the broadcast recorder (1) a recording instruction identifying the programme corresponding to the recording request;
wherein step c comprises performing a search for inexact matches to the recording request, and identifying a programme corresponding to the recording request according to the similarity therebetween.

3. A method according to claim 1, wherein, if a plurality of programmes are found corresponding to the recording request, step d comprises:
sending (S7) a list of some or all of the plurality of programmes to the mobile messaging device (3);
receiving (S8) from the mobile messaging device (3) an indication of one or more programmes from the list; and
sending (S5) to the broadcast recorder (1) said recording instruction identifying the indicated one or more programmes from the list.

4. A method according to claim 1, including, when the recording instruction is sent to the broadcast recorder (1), sending to the mobile messaging device (3) a confirmation message corresponding to the recording instruction.

5. (canceled)

6. (canceled)

7. (canceled)

8. A method of controlling a broadcast recorder (1) with a mobile messaging device (3), comprising the steps of:
a. sending a recording request (S1) from the mobile messaging device (3), and
b. receiving (S5) at the broadcast recorder (1) a recording instruction identifying the programme corresponding to the recording request, based on a search in a programme schedule;
wherein the recording request has one or more of the following characteristics:
i) the recording request comprises a plurality of discrete fields each for partially identifying a programme within the schedule of programmes;
ii) the recording request includes at least a part of one or more of the title, broadcast time, broadcast date and broadcast channel of a programme;
iii) the recording request includes a relative date identifier for identifying a date with reference to the current date;
iv) the recording request does not include information previously communicated to the mobile messaging device (3);
v) the recording request does not include a predetermined code uniquely identifying a programme within the schedule
vi) the recording request does not uniquely identify a programme within the schedule.

9. The method of claim 8, wherein, if a plurality of programmes are found corresponding to the recording request, step d comprises:
receiving at the mobile messaging device (3) a list (S7) of some or all of the plurality of programmes;
sending (S8) from the mobile messaging device (3) an indication of one or more programmes from the list; and
receiving (S5) at the broadcast recorder (1) said recording instruction identifying the indicated one or more programmes from the list.

10. A method according to claim 8, including, receiving at the mobile messaging device (3) a confirmation message corresponding to the recording instruction.

11. A system for controlling a broadcast recorder (1) with a mobile messaging device (3), comprising:
a. means (8) for storing an association between the broadcast recorder (1) and the mobile messaging device (3),
b. a messaging system (2) for passing messages wirelessly to and from the mobile messaging device (3);
c. a broadcast system for broadcasting programmes to the broadcast recorder (1) according to a schedule; and
d. a remote booking system (5) for receiving a recording request from the mobile messaging device (3), performing a search based on the recording request in the schedule, and if a programme is found corresponding to the recording request, sending to the broadcast recorder (1) a recording instruction identifying the programme corresponding to the recording request;
wherein the recording request has one or more of the following characteristics:
i) the recording request comprises a plurality of discrete fields each for partially identifying a programme within the schedule of programmes;
ii) the recording request includes at least a part of one or more of the title, broadcast time, broadcast date and broadcast channel of a programme;
iii) the recording request includes a relative date identifier for identifying a date with reference to the current date;
iv) the recording request does not include information previously communicated to the mobile messaging device (3);
v) the recording request does not include a predetermined code uniquely identifying a programme within the schedule;
vi) the recording request does not uniquely identify a programme within the schedule.

12. A system for controlling a broadcast recorder (1) with a mobile messaging device (3), comprising:
a. means (8) for storing an association between the broadcast recorder (1) and the mobile messaging device (3),
b. a messaging system (2) for passing messages wirelessly to and from the mobile messaging device (3);
c. a broadcast system for broadcasting programmes to the broadcast recorder (1) according to a schedule; and
d. a remote booking system (5) for receiving a recording request from the mobile messaging device (3), performing a search based on the recording request in the schedule, and if a programme is found corresponding to the recording request, sending to the broadcast recorder (1) a recording instruction identifying the programme corresponding to the recording request;
wherein the remote booking system (5) is arranged to perform a search for inexact matches to the recording request, and to identify a programme corresponding to the recording request according to the similarity therebetween.

13. A program product for use in a computer system that executes program steps recorded in a computer-readable media to perform a method for controlling a broadcast recorder with a mobile messaging device, the program product comprising:
a recordable media;
a program of computer-readable instructions recorded in the media and executable by the computer system to perform operations comprising:
a. associating the broadcast recorder with the mobile messaging device,
b. receiving a recording request from the mobile messaging device,
c. performing a search based on the recording request in a schedule of programmes to be broadcast, and if a programme is found corresponding to the recording request,
d. sending to the broadcast recorder a recording instruction identifying the programme corresponding to the recording request;
wherein the recording request has one or more of the following characteristics:
i) the recording request comprises a plurality of discrete fields each for partially identifying a programme within the schedule of programmes;
ii) the recording request includes at least a part of one or more of the title, broadcast time, broadcast date and broadcast channel of a programme;
iii) the recording request includes a relative date identifier for identifying a date with reference to the current date;
iv) the recording request does not include information previously communicated to the mobile messaging device;
v) the recording request does not include a predetermined code uniquely identifying a programme within the schedule;
vi) the recording request does not uniquely identify a programme within the schedule.

14. The computer program product of claim 13, wherein operation c comprises performing a search for inexact matches to the recording request, and identifying a programme corresponding to the recording request according to the similarity therebetween.

15. The computer program product of claim 13, wherein, if a plurality of programmes are found corresponding to the recording request, operation d comprises:
sending a list of some or all of the plurality of programmes to the mobile messaging device;
receiving from the mobile messaging device an indication of one or more programmes from the list; and
sending to the broadcast recorder said recording instruction identifying the indicated one or more programmes from the list.

16. The computer program product of claim 13, including, when the recording instruction is sent to the broadcast recorder, sending to the mobile messaging device a confirmation message corresponding to the recording instruction.
